(19) United States
(12) Patent Application Publication
(10) Pub. No.: US 2010/0182699 A1
(43) Pub. Date: Jul. 22, 2010

(54) INJECTION MOLDING PLASTIC SHEET WITH 3D TEXTURE AND ITS MANUFACTURING PROCESS

(76) Inventor: Yi-Ren Ye, Guangdong (CN)

Correspondence Address: Dr. BANGER SHIA;Patent Office of Bang Shia, 102 Lindencrest Ct., Sugar Land, TX, 77479-5201, US

(21) Appl. No.: 12/664,059

(22) PCT Filed: Jun. 20, 2007
(86) PCT No.: PCT/CN2007/001925

§ 371 Date: Dec. 11, 2009

(51) Int. Cl. G02B 1/10; B05D 5/06; C25D 5/56

(52) U.S. Cl. 359/580; 427/162; 205/165; 427/595

(57) ABSTRACT

In a manufacturing process for an injection molding plastic sheet with 3D texture, a mold with 3D texture is prepared, and then a plastic layer is formed by injection molding on the surface of the mold 3D texture. After the mold is released, a plastic board with 3D texture is formed. A photo-interfering layer is formed on the 3D texture of the plastic layer by vacuum electroplating or direct spraying. Finally, a protective layer with flat surface is formed on the photo-interfering layer.

### BACKGROUND OF THE INVENTION

1. Field of the Invention

The present invention relates to an injection molding plastic sheet with 3D texture and its manufacturing process, and the injection molding plastic sheet is used extensively in the fields of manufacturing lenses, press keys or viewing windows of communication/electronic products.

2. Description of the Prior Art

As to most electronic/communication products (such as lenses, press buttons and viewing windows of mobile phones/personal phone systems) and home electric appliances (such as window panels, press key panels, and decorative panels), different textures are generally formed to provide decoration to the products, and conventional ways of forming texture include a direct surface printing, a surface spraying, a direct electroplating and a dual color plastic injection, etc, and these methods have difficulty of forming a consistent color pattern on various different curved surfaces, arc surfaces or aslant surfaces, and thus the prior art is unable to meet the present requirements.

At present, a texture is formed on a plastic sheet by the following methods: 1. In-Mold Decoration (IMD) Molding: a sheet material printed with a good decoration is placed in a plastic injection mold, and a resin is injected into a backside of the molded sheet material, such that the resin and the sheet material are combined and formed integrally. 2. In-Mould-Label (IML) Molding: This method is substantially the same as the IMD, except that a film is pulled out like a stamped tape after the plastic injection molding process takes place, and a printed pattern is transferred onto a plastic article. 3. In Molding Roller (IMR) Molding: a film with a printed pattern is placed into a metal mold, and transmitted and positioned automatically by a foil feeding machine, and then a resin used for molding is injected into the metal mold and coupled with the film, such that the pattern originally printed onto the film is separated from the film and transferred integrally with the resin as a whole. However, the aforementioned IMD/IML methods require a complicated manufacturing process, and come with a low productivity. Although the IMR method can be automated for mass production, yet the pattern layer printed onto the surface of a product generally has a thickness of several microns, and thus the printed pattern layer may be worn out or faded easily, and such method generally results in a poor appearance of the product, and incurs a high defective rate.

### SUMMARY OF THE INVENTION

The primary object of the present invention is to overcome the shortcomings of the prior art by providing an injection molding plastic sheet with 3D texture and its manufacturing process.

To achieve the aforementioned objective, the present invention provides a manufacturing process of an injection molding plastic sheet with 3D texture, and the process comprises the steps of:

(1) preparing a mold in advance, wherein the mold has a 3D texture;

(2) forming a plastic layer onto a surface with the 3D texture of the mold by a plastic injection molding process, and obtaining a plastic sheet material with a 3D texture after the mold is released;

(3) forming an optical interference coating on the 3D texture of the plastic sheet material; and

(4) forming a flat surfaced protection film layer onto the optical interference coating.

The optical interference coating is formed by a vacuum electroplating process or a direct spraying method.

The protection film layer is a plastic layer formed onto the optical interference coating by a plastic injection process.

The protection film layer is formed by a method comprising the steps of latching a surface of the plastic sheet material having the optical interference coating in an inverted direction into the mold having an optical solidification limb; going through a rolling press process, an optical solidification process, and a demolding process, and forming an optical solidification plastic layer onto the optical interference coating of the plastic sheet material.

The optical solidification plastic is an UV ink or an UV dye.

The 3D texture includes a line, a text, a pattern or a symbol.

An injection molding plastic sheet with 3D texture comprises:

a plastic sheet material, having a 3D texture therein;

an optical interference coating, disposed on a surface of the 3D texture of the plastic sheet material; and

a flat surfaced protection film layer, disposed on the optical interference coating.

The optical interference coating is a vacuum electroplating layer or a spraying layer.

The protection film layer is a plastic layer.

The protection film layer is an optical solidification plastic layer. The optical solidification plastic layer is an UV ink layer or an UV dye layer.

The 3D texture includes a line, a text, a pattern or a symbol.

The present invention has the effect of forming a 3D (three-dimensional) texture through a mold by a plastic injection process, and then forming a corresponding optical interference layer, and finally using a special manufacturing method of a protection film layer to produce a plastic sheet with 3D texture having a good decoration effect, and the plastic sheet provides a better visual effect, such that the invention has the advantages of providing an excellent decoration, a simple and easy manufacturing method, and a simple operation and implementation.

### BRIEF DESCRIPTION OF THE DRAWINGS

FIG. 1 is a flow chart of the present invention;

FIG. 2 is another flow chart of the present invention;

FIG. 3 is a schematic view of a product structure of the present invention;

FIG. 4 is a schematic view of forming a texture on a viewing window in accordance with the present invention;

FIG. 5 is a schematic view of forming a texture on a press button in accordance with the present invention; and

FIG. 6 is a schematic view of forming a texture on a viewing window and a press button integrally in accordance with the present invention.

### DETAILED DESCRIPTION OF THE PREFERRED EMBODIMENTS

Embodiments of the present invention will now be described, by way of example only, with reference to the accompanying drawings.

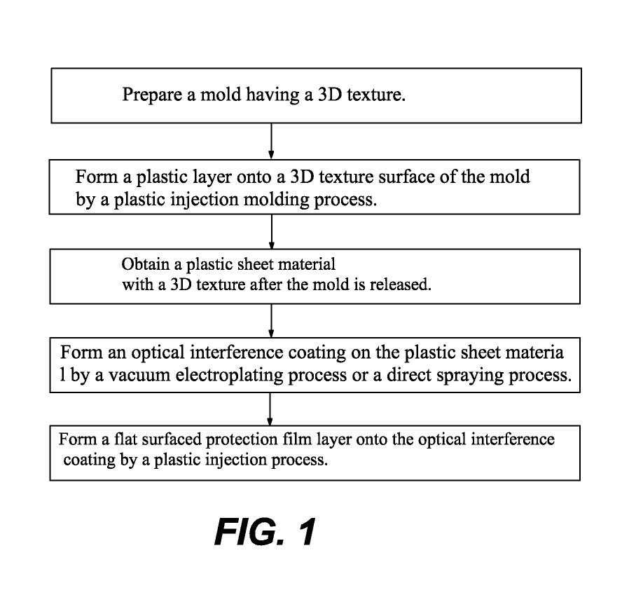

With reference to FIG. 1 for a manufacturing process of an injection molding plastic sheet with 3D texture, the manufacturing process comprises the steps of:

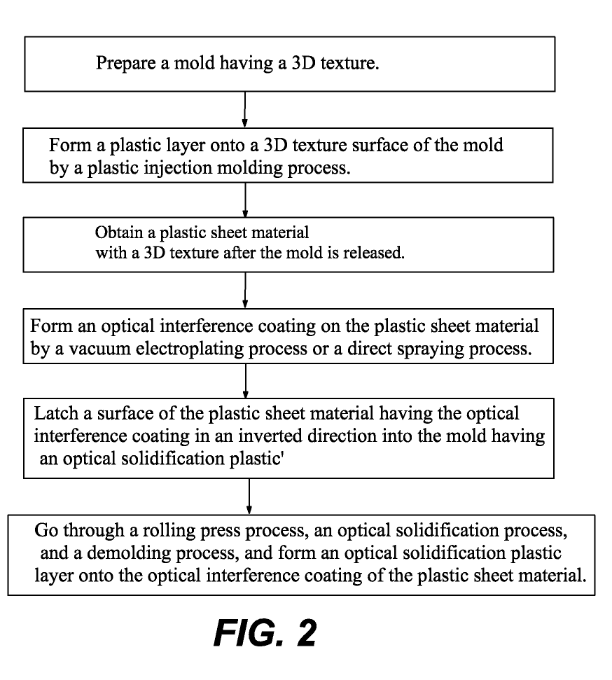

preparing a mold in advance, wherein the mold has a 3D texture; forming a plastic layer onto a surface with the 3D texture of the mold by a plastic injection molding process, and obtaining a plastic sheet material with a 3D texture after the mold is released; forming an optical interference coating on the 3D texture of the plastic sheet material by a vacuum electroplating process or a direct spraying process; and finally forming a flat surfaced protection film layer onto the optical interference coating. The protection film layer is used for preventing the optical interference layer from being worn out and filling a rough wavy surface formed during the process of forming the 3D texture. The protection film layer is a plastic layer formed onto the optical interference coating by a plastic injection method. Of course, the protection film layer as shown in FIG. 2 is formed by a method comprising the steps of latching a surface of the plastic sheet material having the optical interference coating in an inverted direction into the mold having an optical solidification plastic (with UV ink or dye); going through a rolling press process, an optical solidification process, and a demolding process, and forming an optical solidification plastic layer (with UV ink or dye) onto the optical interference coating of the plastic sheet material.

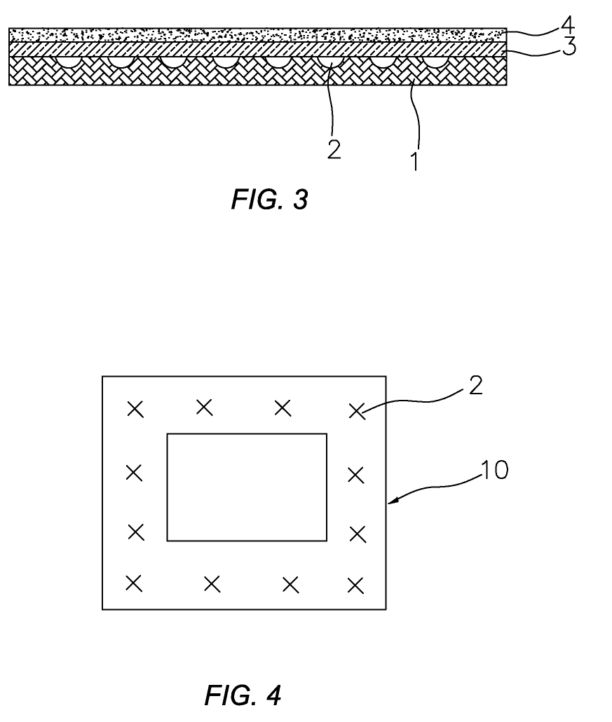

With reference to FIG. 3 together, an injection molding plastic sheet with 3D texture comprises:

a plastic sheet material 1, having a 3D texture 2;

an optical interference coating 3, disposed on a surface of the 3D texture 2 of the plastic sheet material 1, wherein the optical interference coating 3 is an electroplated layer formed by a vacuum electroplating process or a spraying layer formed by a direct spraying process; and a flat surfaced protection film layer 4, disposed on the optical interference coating 3, wherein the protection film layer 4 is a plastic layer formed by a plastic injection process. Of course, the protection film layer can also be formed by a method comprising the steps of latching a surface of the plastic sheet material having the optical interference coating in an inverted direction into the mold having an optical solidification plastic (UV ink or dye); going through a rolling press process, an optical solidification process, and a demolding process, and forming an optical solidification plastic layer (UV ink layer or dye layer) onto the optical interference coating of the plastic sheet material.

With reference to FIG. 4 for a schematic view of forming a texture on a viewing window in accordance with the present invention, the product produced by the process in accordance with the present invention is cut into the shape of a viewing window 10, and the viewing window 10 also has a 3D texture 2, and the viewing window 10 provides a better visual effect to users, and thus the present invention provides an excellent decoration.

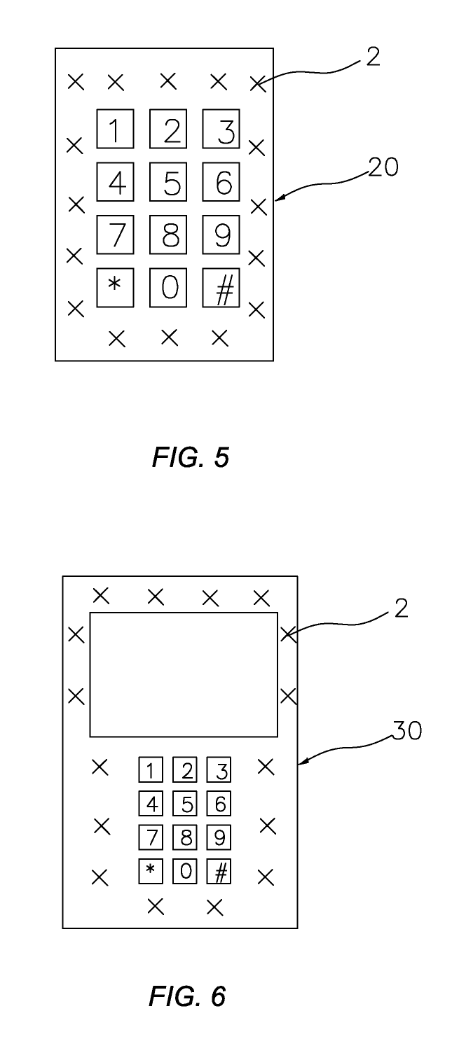

With reference to FIG. 5 for a schematic view of forming a texture on a press button in accordance with the present invention, this preferred embodiment is substantially the same as the aforementioned preferred embodiments, except that the sheet material of this preferred embodiment is cut into a structure of a press key 20 instead of a viewing window 10, and the press key 20 also has a 3D texture 2, and the process of forming the texture is the same as those of the aforementioned preferred embodiments, and thus will not be described here again.

With reference to FIG. 6 for a schematic view of forming a texture on a viewing window and a press button integrally in accordance with the present invention, this preferred embodiment is substantially the same as the aforementioned preferred embodiments, except that the sheet material of this preferred embodiment is cut into a structure of a sheet material 30 integrated with a viewing window and a press key, The sheet material 30 also has a 3D texture 2, and the texture is formed by the same method as the aforementioned two preferred embodiments, and thus will not be described here again.

In the foregoing preferred embodiment, the 3D texture includes a line, a text, a pattern or a symbol.

In summation of the description of the aforementioned preferred embodiments, the present invention has the effect of forming a 3D (three-dimensional) texture through a mold by a plastic injection process, and then forming a corresponding optical interference layer, and finally using a special manufacturing method of a protection film layer to produce a plastic sheet with 3D texture having a good decoration effect, and the plastic sheet provides a better visual effect, such that the invention has the advantages of providing an excellent decoration, a simple and easy manufacturing method, and a simple operation and implementation.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A manufacturing process of an injection molding plastic sheet with 3D texture, comprising the steps of:
(1) preparing a mold in advance, wherein the mold has a 3D texture;
(2) forming a plastic layer onto a surface with the 3D texture of the mold by a plastic injection molding process, and obtaining a plastic sheet material with a 3D texture after the mold is released;
(3) forming an optical interference coating on the 3D texture of the plastic sheet material; and
(4) forming a flat surfaced protection film layer onto the optical interference coating.

2. The manufacturing process of an injection molding plastic sheet with 3D texture as claimed in claim 1, wherein the optical interference coating is formed by a vacuum electroplating process or a direct coating process.

3. The manufacturing process of an injection molding plastic sheet with 3D texture as claimed in claim 1 or 2, wherein the protection film layer is a plastic layer formed onto the optical interference coating by a plastic injection process.

4. The manufacturing process of an injection molding plastic sheet with 3D texture as claimed in claim 1 or 2, wherein the protection film layer includes the steps of latching a surface of the plastic sheet material having the optical interference coating in an inverted direction into the mold having an optical solidification limb; going through a rolling press process, an optical solidification process, and a demolding process, and forming an optical solidification plastic layer onto the optical interference coating of the plastic sheet material.

5. The manufacturing process of an injection molding plastic sheet with 3D texture as claimed in claim 4, wherein the optical solidification plastic is an UV ink or an UV dye.

6. The manufacturing process of an injection molding plastic sheet with 3D texture as claimed in claim 1 or 2, wherein the 3D texture includes a line, a text, a pattern or a symbol.

7. An injection molding plastic sheet with 3D texture manufactured by the manufacturing method as claimed in claim 1, comprising:
a plastic sheet material, having a 3D texture therein;
an optical interference coating, disposed on a surface of the 3D texture of the plastic sheet material; and
a flat surfaced protection film layer, disposed on the optical interference coating.

8. The injection molding plastic sheet with 3D texture as claimed in claim 7, wherein the optical interference coating is a vacuum electroplating layer or a spraying layer.

9. The injection molding plastic sheet with 3D texture as claimed in claim 7 or 8, wherein the protection film layer is a plastic layer.

10. The injection molding plastic sheet with 3D texture as claimed in 7 or 8, wherein the protection film layer is an optical solidification plastic layer.

11. The injection molding plastic sheet with 3D texture as claimed in 10, wherein the optical solidification plastic layer is an UV ink layer or an UV coating layer.

12. The injection molding plastic sheet with 3D texture as claimed in 7, wherein the 3D texture includes a line, a text, a pattern or a symbol.
